(19) United States
(12) Patent Application Publication
(10) Pub. No.: US 2026/0348531 A1
(43) Pub. Date: Nov. 5, 2026

(54) MANIFOLD OF A FLUID SUPPLY SYSTEM, AND VALVE UNIT

(71) Applicant: Eugen Seitz AG, Wetzikon (CH)

(72) Inventors: Alexander MÜLLER, Worndorf (DE); Beat SCHMID, Zimikon (CH); Michael BRONNER, Balterswil (CH)

(73) Assignee: Eugen Seitz AG, Wetzikon (CH)

(21) Appl. No.: 19/115,534

(22) PCT Filed: Sep. 25, 2023
(86) PCT No.: PCT/EP2023/076341

§ 371 Date: Mar. 26, 2025

(30) Foreign Application Priority Data
Sep. 27, 2022 (EP) 22198108.7

(51) Int. Cl. F17C 13/04; F16K 15/18; F17C 5/02; F17C 7/02

(52) U.S. Cl. CPC F17C 13/04; F16K 15/184; F17C 5/02; F17C 7/02; F17C 2221/012; F17C 2265/065; F17C 2270/0139

(57) ABSTRACT

A distributor of a fluid supply system, in particular of a hydrogen filling station, has lines for connecting storage containers to stations, and valve units for selectively opening and closing the connection between the storage containers and the stations. The lines are arranged in a matrix formation in a line module. The valve units are releasably secured in a matrix formation on the line module. The distributor permits a compact and space-saving arrangement of valve units, which can also be easily exchanged. Each valve unit preferably has a main valve, a pilot valve and a check valve.

### TECHNICAL FIELD

The present invention relates to a manifold of a fluid supply system, in particular of a hydrogen filling station, and to a valve unit, in particular for use in a manifold of a fluid supply system.

### PRIOR ART

Fluid supply systems, in particular a hydrogen fueling installation, and especially a hydrogen filling station, have one or a plurality of high-pressure storage containers in which liquid or compressed gaseous hydrogen is provided for filling containers, or for fueling motor vehicles or railroads. The high-pressure storage containers are also referred to as storage containers, pressurized tanks, banks or storage banks.

In order to fully fuel a vehicle as fast as possible, the hydrogen is obtained from a plurality of storage containers in succession. The further the filling of the vehicle has progressed, the higher the pressure must be in the storage containers. Therefore, the pressures in the individual storage containers differ in value, usually being 350 bar, 500 bar, 700 bar and 1000 bar. However, storage containers with other pressure levels are also possible. Downtimes when switching to other storage containers can be minimized if pilot-controlled valves are used for opening and closing the lines. However, since the pilot-controlled valves often open more rapidly than they close, check valves are furthermore required in order to prevent a return flow into the storage container which is no longer used and has a lower pressure.

Fluid supply systems usually comprise more than one consumer station at which filling takes place. Thus, a filling station usually has more than one fuel dispenser. Allocating the fluid flows from the storage containers to the consumer stations therefore requires a multiplicity of pipelines, pilot-controlled valves and check valves.

The various pipelines, valves and check valves are disposed in so-called “flow panels” or “valve panels”. These assemblies have many connection points which have to be sealed. The multiplicity of connection points increases the risk of a leakage. If there is a leakage, the latter is often difficult to access, and thus difficult to eliminate.

The replacement of the valves and check valves subjected to wear also requires time, because they are often difficult to access, and the subsequent re-sealing of the connection points is complex. This causes long periods of downtime of the installation, i.e. of the fluid supply system, and high maintenance costs.

Commissioning of the “flow panels” is also time consuming and requires skills. This is because said “flow panels” are usually assembled on site, due to their size and weight. The first operational check can therefore also only be performed on site. Usual assembly times are often 5 to 7 days.

An additional disadvantage of the known “flow panels” lies in that they are relatively large and heavy. They often require a dedicated cabinet and thus additional space. It is almost impossible for them to be installed conjointly with other functional groups in a common container. However, floor space is expensive, in particular in the case of filling stations, so that the “flow panels” increase the rental costs or the purchase price for the site of the installation.

A “flow panel” for eight storage containers and four fuel dispensers typically has a dimension of approx. 2×2×1 m, and weighs more than 600 kg. Furthermore, it has approximately 288 CT (cone-and-thread) connections, all of which have to be tight.

U.S. Pat. No. 8,707,977 B2 discloses a manifold for a fluid supply system in which a smaller container is filled in a cascading manner from a plurality of high-pressure containers. The manifold comprises a solid body having receptacle bores for check valves, and receptacle bores for pressure sequence valves. In each case one check valve and one pressure sequence valve are connected by way of one external line, so as to form a unit. They can be inserted as a common cartridge into the bores of the manifold body. A sensor line leads from the smaller container to be filled to the pressure sequence valves which open or close, depending on the pressure in the smaller container. A separate bore enables refilling of the high-pressure containers. This manifold is suitable for filling a single container, but not for an installation with controlled valves for supplying a plurality of consumer stations, for example because it is not possible to control the individual valves.

### SUMMARY OF THE INVENTION

It is an object of the invention to achieve a manifold for a fluid supply system, in particular of a hydrogen filling station, which eliminates the above-mentioned issues of the known flow panels.

This object is achieved by a manifold having the features of claim 1.

The manifold according to the invention has lines for connecting storage containers to stations, and valve units for selectively opening and closing the connection between the storage containers and the stations. The lines are disposed in the form of a matrix in a line module, and the valve units in the form of a matrix are releasably fastened on the line module.

The use of a line module, to which the valves are attached, facilitates commissioning. The assembly time is massively reduced. The latter is considerably less than 1 day, depending on the embodiment.

The arrangement of the lines and valve units according to the invention enables easy access to all valve units. The latter can thus be easily replaced without lines having to be removed, or additional seals having to be released. Maintenance times and maintenance costs as well as downtime periods of the filling station are thus minimized.

All valve units are preferably disposed on the same side of the line module. In this way, all valve units are accessible from the same side. If the manifold is disposed in a cabinet, this side can form the front side and thus the most accessible side. This also facilitates and reduces maintenance.

Furthermore, the arrangement in the form of a matrix enables scaling of the manifold. This means that the same arrangement can be used when using different quantities of storage containers and stations. This simplifies the planning and the construction of manifolds of this type.

The stations are at least one consumer station, preferably a plurality of consumer stations and/or at least one cryopump station. The consumer stations are preferably fuel dispensers or other filling devices. The cryopump station serves for filling the storage containers. Depending on the embodiment, only consumer stations are present. In other embodiments, at least one consumer station, preferably a plurality of consumer stations, and a single cryopump station are present.

Thanks to the arrangement in the form of a matrix, the manifold can also be designed to be more compact and thus lighter.

The line module preferably consists of at least one solid component, wherein the lines are bores in the at least one solid component. The component is preferably made of metal, in particular of steel. As a result, the manifold per se has no pipelines. The connection points and thus the potential leakage points can be massively reduced.

The lines in the form of bores in a solid component are extremely space-saving. The line module can be designed to be relatively small, and is correspondingly light.

A manifold in an embodiment having a solid component and bores, which is conceived for eight high-pressure storage containers and four fuel dispensers, weighs approximately 200 kg and requires approximately 0.5×0.5×0.2 m in terms of installation space, including the valves. Furthermore, it requires only thirteen connection points if the return filling is likewise enabled in the manifold by way of a cryopump.

In one embodiment, the line module consists of a single solid component. The bores can be disposed so as to be relatively close to one another. The line module is of an optimally dense design. The line module and thus the manifold are extremely compact.

In another embodiment, the line module has a plurality of cuboid elongate components, wherein each component establishes the connection to one storage container or to one station, and wherein a plurality of components of this type are able to be joined to one another so as to form common lines. This variant in the form of building blocks enables a simple expansion or reduction of an existing installation to more or fewer storage containers and/or fuel dispensers. Furthermore, the production costs in producing the line module can be optimized, because the produced components can be assembled according to customer requirements.

In a preferred embodiment, each valve unit has a main valve, a pilot valve for controlling the main valve, and a check valve, which form a common module. This module is able to be fastened to the line module and released from the line module as a unit.

The valve unit is preferably designed in such a manner that a flow path of the fluid through the valve unit from an inlet to an outlet of the valve unit is U-shaped or V-shaped. As a result, the inlet and the outlet are disposed on the same side, and the valve unit per se is of a compact design. By disposing the inlet and the outlet on the same side, having a U-shaped flow path, a V-shaped flow path, or having an alternative design of the flow path, the valve units and thus also the manifold can be designed to be very compact. The valve units can be fastened from the opposite side. Maintenance is facilitated. The outlet and the inlet preferably extend so as to be almost parallel to one another.

The piston of the main valve preferably moves in a direction which is almost perpendicular to the direction of movement of the piston of the check valve. The pilot valve for pilot-controlling the main valve is preferably located in the extension of the check valve. The direction of movement of the piston of the pilot valve preferably extends parallel to the direction of movement of the piston of the check valve and perpendicularly to the piston of the main valve. The three pistons preferably open into a common valve chamber, the latter being part of the fluid path through the valve unit. The output of the main valve, the output of the pilot valve, and the input of the check valve preferably open into the common valve chamber.

At least the main valve and the check valve are preferably disposed in a common housing. The pilot valve is preferably likewise integrated into this housing, or screwed to the latter. This leads to a very compact design of the valve unit. In this way, the plurality of valve units can be disposed in an extremely space-saving manner on the line module.

In preferred embodiments, one part of the lines of the line module are storage container lines, wherein each storage container line connects in each case one storage container to a first sub-quantity of the valve units. Another part of the lines of the line module in this embodiment are station lines, wherein each station line connects a second sub-quantity of the valve units to in each case one consumer station. This arrangement enables a preferred embodiment in which the first sub-quantity and the second sub-quantity are not identical, wherein however exactly one valve unit of the manifold is present in the first and the second sub-quantity.

In preferred embodiments, the storage container lines extend in a first direction of a matrix, and the station lines extend in a second direction of the matrix that extends perpendicularly to the first direction, wherein the storage container lines extend so as to be spaced apart from the station lines.

These arrangements make it possible for the valve units to be in each case assigned to an unequivocal combination of one storage unit and one station.

In preferred embodiments, first valve lines are present, which extend from the storage container lines to the valve units at an angle to the storage container lines, and wherein second valve lines are present, which extend from the station lines to the valve units at an angle to the station lines. In this way, the valve units can be disposed on the line module. No clearances are required in order to insert the valve units into the block of the line module. The line module can be designed to be relatively narrow and thus light.

Preferably, exactly one storage container line is present per storage container, and exactly one station line is present per station, wherein the storage container line and the station line extend without any interruption and rectilinearly in the line module. This in turn reduces the size of the line module and minimizes connection point is to be sealed.

The station is preferably a consumer station, in particular a fuel dispenser. However, said station can also be a cryopump station which serves for filling the storage containers. In one embodiment, at least one station is a consumer station, and at least one additional station is a cryopump station. The valve units assigned to the at least one consumer station herein differ at least in terms of their arrangement from the valve units assigned to the cryopump station.

Depending on the embodiment, the valve units assigned to the cryopump station are designed identically to the valve units already mentioned, wherein the former are disposed in reverse. In other embodiments, however, other types of valve units are used.

The valve unit according to the invention has a main valve, a pilot valve for controlling the main valve, and a check valve, which form a common module which is able to be assembled and removed as a unit. The main valve, the pilot valve and the check valve are mutually disposed in such a manner that a U-shaped or a V-shaped flow path for a flow of a fluid from an inlet into the valve unit to an outlet from the valve unit is formed. The valve unit is designed to be extremely compact and space-saving. Thanks to the flow path extending in a U-shaped or V-shaped manner, the valve unit can be used in many ways, because the inlet and the outlet are located on the same side. The valve unit, and the alternatives and variants already mentioned above, can be used in particular, but not exclusively, in a manifold according to the invention described in this text. In particular, the flow path may have another shape, in particular if the inlet and the outlet are disposed on the same side. A parallel course of the flow path in the region of the inlet and the outlet is preferable.

Further embodiments are laid out in the dependent claims.

### BRIEF DESCRIPTION OF THE DRAWINGS

Preferred embodiments of the invention are described in the following with reference to the drawings, which are merely for the purpose of illustrating the present preferred embodiments of the invention and are not to be interpreted as limiting the same. In the drawings:

FIG. 1 shows a schematic illustration of a hydrogen filling station having a manifold according to the invention;

FIG. 2 shows a perspective illustration of the manifold according to the invention having a line module and valve units, in a first embodiment;

FIG. 3 shows part of the manifold according to FIG. 2;

FIG. 4 shows the line module of the manifold according to FIG. 2, having an assembled valve unit according to the invention;

FIG. 5 shows a perspective view of the line module according to FIG. 4 from below, without valve units;

FIG. 6 shows a perspective view of the line module according to FIG. 5 from the front;

FIG. 7 shows the perspective view of the line module according to FIG. 6, having a transparent illustration of an upper region of the manifold;

FIG. 8 shows the perspective view of the line module according to FIG. 6, having a transparent illustration of the manifold and with an illustration of only part of the bores;

FIG. 9 shows the exploded illustration of the line module according to FIG. 6, having an assembled valve unit according to the invention;

FIG. 10 shows a perspective view of the valve unit according to the invention;

FIG. 11 shows a schematic illustration of the arrangement of the three valves of the valve unit;

FIG. 12 shows a longitudinal section through the valve unit according to FIG. 10;

FIG. 13 shows a perspective illustration of the line module according to the invention in a second embodiment; and

FIG. 14 shows an additional perspective illustration of the line module according to FIG. 13, having some assembled valve units.

### DESCRIPTION OF PREFERRED EMBODIMENTS

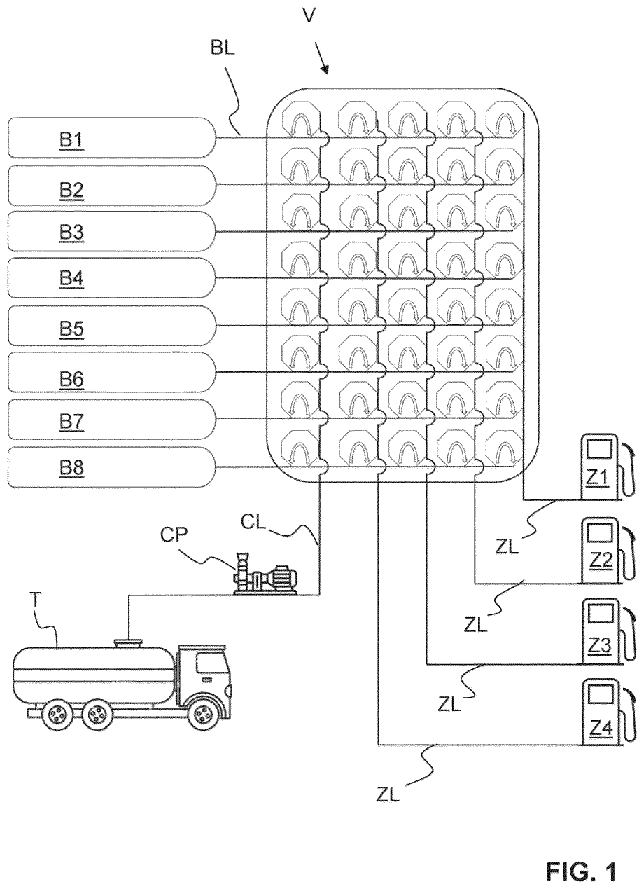

Schematically illustrated in FIG. 1 is a filling station. The latter has a plurality of, presently eight, storage containers B1-B8, in which a highly pressurized fluid is stored. The fluid in this example is hydrogen. The high-pressure storage containers B1-B8 have different pressures, wherein two or a plurality of storage banks B1-B8 may have identical pressures. The pressures are preferably 350 bar, 500 bar, 700 bar und 1000 bar.

First lines BL lead from each storage container B1-B8 to a distributor V, also referred to as a manifold. A cryopump station CP having a cryopump is connected to the manifold V by way of a second line CL.

A plurality of, presently four, fuel dispensers Z1-Z4 are connected to the manifold V by way of third lines ZL.

The cryopump station CP and the fuel dispensers Z1-Z4 in this text are conjointly also referred to as stations.

For filling the storage containers B1-B8, the hydrogen is usually directed from a tanker T, through the cryopump station CP, the second line CL, the manifold V and the first lines BL, into the individual storage containers B1-B8.

For fueling vehicles not illustrated here, the hydrogen is directed from the storage containers B1-B8 by way of the first lines BL, the manifold V and the third lines ZL to the individual fuel dispensers Z1-Z4. In the process, switching takes place from a storage container B1-B8 with a low pressure to a storage container B1-B8 with a higher pressure during fueling, depending on the filling level of the vehicle tank. Switching takes place by means of the manifold V which has pilot-controlled valves that are controlled according to the parameters of an electronic controller. The controller is not illustrated here. Controllers of this type for controlling valves for filling vehicle tanks at filling stations are known.

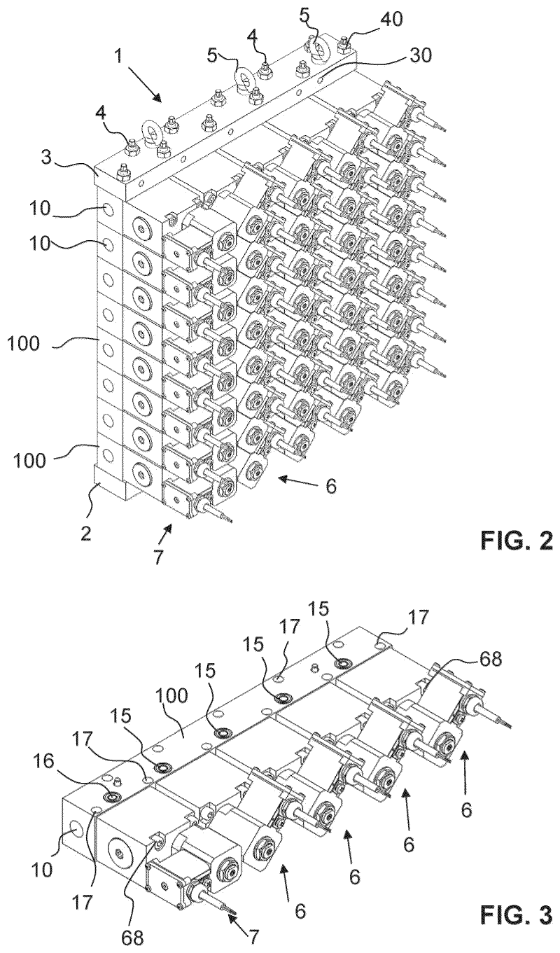

A first exemplary embodiment of the manifold according to the invention is illustrated in FIGS. 2 to 12.

Said manifold has a plurality of line module elements 100 which are assembled so as to form a common line module 1. The line module elements 100 are cuboid, elongate and solid components having a plurality of bores. They are preferably made of metal, more preferably of steel. The bores have been created by boring, erosion boring, laser boring, or in any other way.

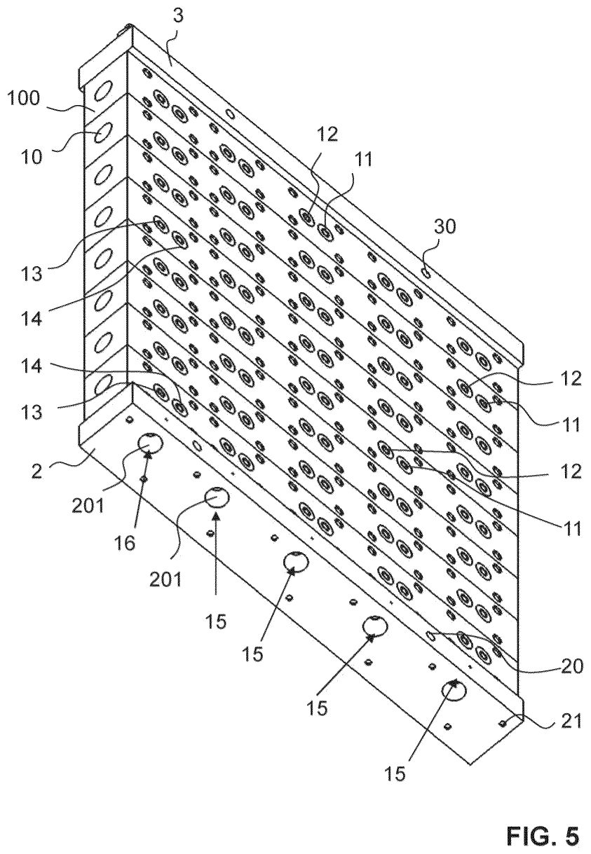

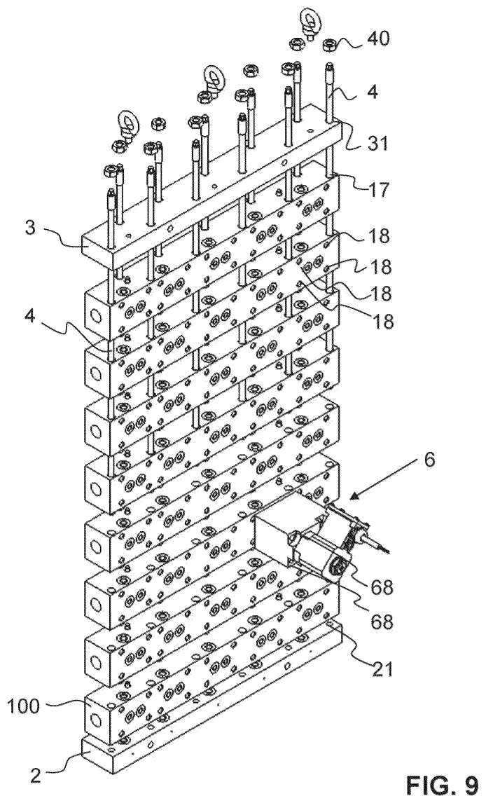

A plurality of line module elements 100 are stacked on top of one another. A first, presently lower, end is formed by a first end beam 2. A second, presently upper, end is formed by a second end beam 3. The line module elements 100 are conjointly screwed to the first and the second end beam 2, 3. The long connecting screws 4 and their nuts 40 can be readily seen in FIGS. 2 and 9. The line module elements 100 have corresponding through-bores 17, as can be readily seen in FIGS. 3 and 9. For this purpose, the second end beam 3 also has through-bores 31 which are identified in FIG. 9. Corresponding threaded openings 21 are present in the first end beam 2. This can be seen in FIG. 5.

In this example, eight line module elements 100 are stacked on top of one another; in each case one line module element 100 for one of the eight storage containers B1-B8 of this example. If more or fewer storage containers B1-B8 are present, the number of line module elements 100 is chosen accordingly. Thanks to the modular assembly, identical components can thus be used for different applications.

A plurality of valve units 6, 7 are disposed on each line module element 100. In this example, there are five valve units. Four of the latter serve as a connection between one of the eight storage containers B1-B8 and the four fuel dispensers Z1-Z4. This means that each of the valve units of this bar is assigned to the same storage container B1-B8 but to a different fuel dispenser Z1-Z4. In this text, these valve units are referred to as first valve units 6 or fuel dispenser valves. The fifth valve unit, presently referred to as the second valve unit 7 or cryopump valve, serves for filling the storage containers B1-B8 by way of the cryopump station CP. If the manifold V is to be used for more than four fuel dispensers, the line module element 100 is correspondingly produced with more bores and with a greater length. In the case of fewer than four fuel dispensers, individual bores can be tightly closed. Alternatively, the line module element 100 can be designed to be correspondingly shorter.

As can be readily seen in FIGS. 2 and 3, all first valve units 6 are identically aligned. The second valve units 7 are aligned differently than the first valve units 6, but are likewise all identically aligned. As can be seen in FIG. 2, this forms a very dense and space-saving pack on the line module 1. Nevertheless, the individual first and second valve units 6, 7 are readily accessible and can be individually replaced. This facilitates maintenance.

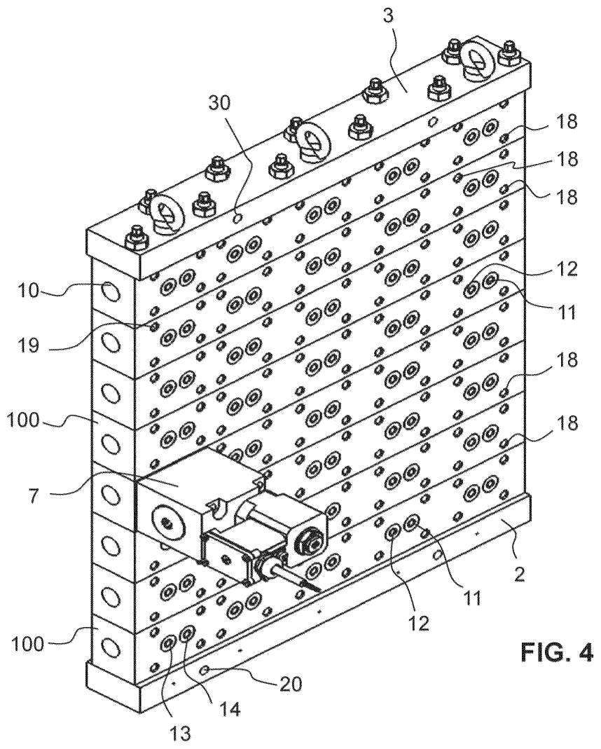

The individual valve units 6, 7 are screwed to the line module element 100 by means of screws 68. The screws 68 can be readily seen in FIG. 3. There are usually four screws. The corresponding threaded bores 18 in the line module element 100 can be seen in FIGS. 4 and 9.

The manifold V thus assembled can be easily transported. For this purpose, eyes 5 are fastened to the second beam 3, as can be seen in FIGS. 2 and 9. This facilitates assembly and maintenance. It is furthermore advantageous that the manifold can be completely assembled and tested in the factory. Fastening bores 20, 30, see FIG. 4, allow the manifold V to be fastened to a device or to a profile.

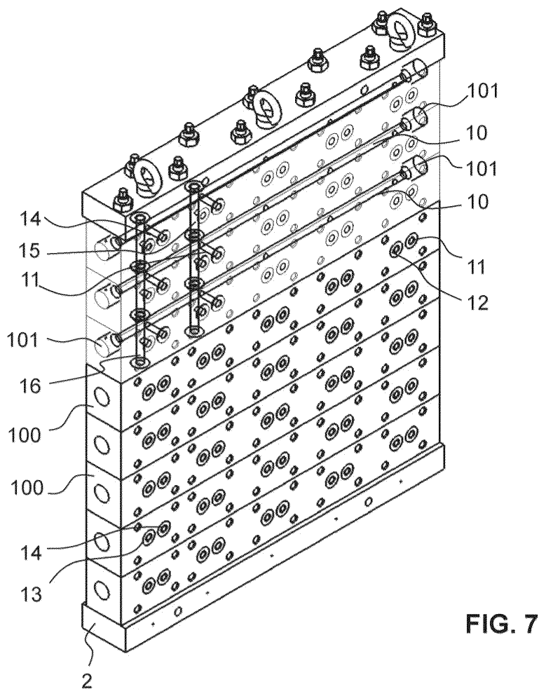

Each line module element 100 is identically constructed. Each has a bore in the longitudinal direction of the line module element 100, said bore forming a storage container line 10. This can be readily seen in FIGS. 3 and 7. Only some of the lines are visible in FIG. 7. However, the remaining line module elements 100 are of identical design.

The bore can be a through-bore or a blind bore. If this is a through-bore, one end is tightly closed. One end or both ends of the storage container line 10 have an expansion 101 in order to enable a tight connection to one of the first lines BL. This connection is usually a CT connection.

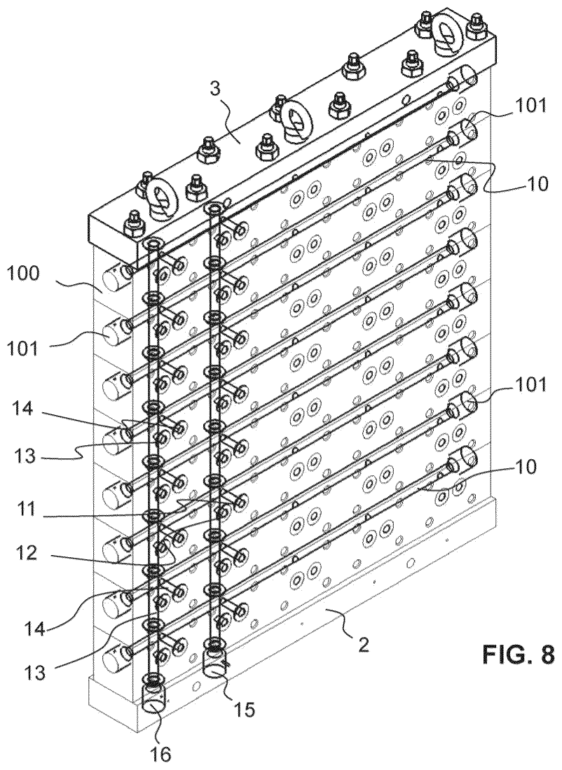

Furthermore, each line module element 100 has transverse bores which extend perpendicularly to the storage container line 10 and so as to be spaced apart from the latter, and perpendicularly to the threaded bores 18. These transverse bores extend so as to be parallel to the through-bores 17. They form parts of lines to the stations, i.e. to the fuel dispensers Z1-Z4 and to the cryopump station CP. In this example, there are four lines for the four fuel dispensers Z1-Z4, presently referred to as fuel dispenser lines 15, and one line for the cryopump station CP, presently referred to as the cryopump line 16. They can be readily seen in FIGS. 3, 7 and 8. Only part of the lines 15, 16 are illustrated in FIGS. 7 and 8. However, they extend across all line module elements 100. Furthermore, only one line 15 is in each case illustrated. However, three additional lines 15 of this type extend parallel thereto, as can be seen in FIGS. 3 and 5 by means of the bores. The lines 15 and 16 extend separately from the storage container lines 10. These lines do not penetrate one another. The storage container lines 10 also extend separately and so as to be mutually spaced apart. The same applies to the lines 15 and 16.

It can be moreover seen in FIG. 5 that the first end beam 2 also has corresponding bores for the lines 15, 16. The bores of the first end beam 2 preferably have expansions 201 so as to enable a tight connection to in each case one of the third lines ZL. These connections are usually CT connections.

The second end beam 3 preferably does not have any bores of this type, but seals the corresponding ends of the bores of the lines 15, 16 of the uppermost line module element 100. For this purpose, O-rings are present as sealing elements in some embodiments. In other embodiments, other known sealing elements are used for this purpose.

The bores for the lines 15, 16 in the individual line module elements 100 are mutually sealed by means of suitable sealing elements. For this purpose, O-rings and support rings, which are placed into grooves surrounding the lines 15, 16, are used in some embodiments. The grooves can be readily seen in FIG. 3. A corresponding mirror face is present on the opposite side of each line module element 100, thus on the side that faces the adjacent line module element 100. Alternatively, other sealing elements with and without O-rings may also be used.

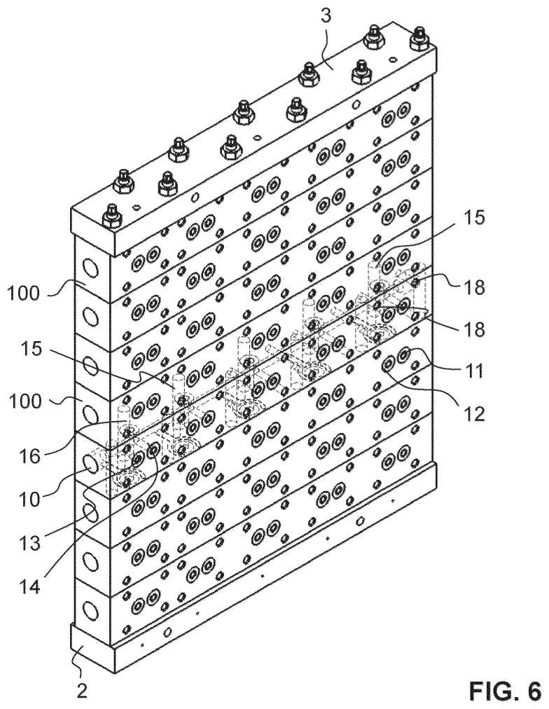

Additional bores in the line module elements 100 are present in the direction perpendicular to the longitudinal direction of the line module elements 100 and perpendicular to the bores for the lines 15, 16. Said additional bores are disposed in pairs, wherein they are disposed so as to correspond to the input and output openings of the valve units 6, 7. They are provided with the reference signs 11, 12, 13 and 14 in FIGS. 4 to 8, and are presently referred to as valve lines. For reasons of improved clarity, only part of the interior region of the line module 1 is illustrated in FIGS. 6 to 8. This part extends identically across the remaining region of the line module elements 100.

The first valve lines 11 extend from the outer surface of the line module elements 100 to one of the storage container lines 10. This can be readily seen in FIGS. 6 to 8. Said first valve lines open into the storage container lines 10. The second valve lines 12 extend adjacent thereto, likewise from the outer surface of the line module elements 100 to one of the fuel dispenser lines 15. Said second valve lines open into the fuel dispenser lines 15.

The third valve lines 13 are the equivalent of the second valve lines 12. Said third valve lines extend from the outer surface of the line module elements 100 to the cryopump line 16, and they open into the cryopump line 16. The fourth valve lines 14 are the equivalent of the first valve lines 11. Said fourth valve lines extend from the outer surface of the line module elements 100 to one of the storage container lines 10 and open into the latter.

The first valve lines 11 are tightly connected in each case to one inlet 63 of one of the first valve units 6. The second valve lines 12, disposed adjacent thereto, are connected to an outlet 64 of the corresponding first valve unit 6. As a result, in the case of an open first valve unit 6, the hydrogen can flow from the corresponding storage container B1-B8 to the corresponding fuel dispenser Z1-Z4. A return flow is prevented thanks to a check valve 62 which is disposed in the first valve unit 6.

The third valve lines 13 are tightly connected in each case to one inlet of one of the second valve units 7. The fourth valve lines 14, disposed adjacent thereto, are connected to an outlet of the corresponding second valve unit 7. As a result, in the case of an open second valve unit 7, the hydrogen can flow from the cryopump station CP into the corresponding storage container B1-B8. A return flow is prevented thanks to a check valve which is disposed in the second valve unit 7.

The line module 1 is preferably provided with a uniform pitch of bores that are used as valve lines. This means that the third valve lines 13 are designed so as to be identical to the second valve lines 12, and the fourth valve lines 14 are designed so as to be identical to the first valve lines 11. This facilitates production.

The first and the second valve units 6, 7 can be designed differently. However, if they are designed identically, as in the example illustrated, a reversed arrangement of the second valve units 7 is sufficient in order to swap the inlets and the outlets. This can be readily seen in FIGS. 2 and 3.

As has already been mentioned, the first and the second valve units 6, 7 are screwed to the line module. Sealing is guaranteed by O-rings or other suitable sealing elements which are preferably disposed in grooves about the valve lines 11, 12, 13, 14. The O-rings are not illustrated. The grooves can be seen in FIG. 7.

The first and the second valve units 6, 7 can be designed differently. They preferably have a pilot-controlled switching valve and a check valve. Each of the valve units preferably comprises a main valve 60, a pilot valve 61 and a check valve 62. The pilot valve 61 is also referred to as a control valve. It is usually a solenoid valve. The latter controls the main valve 60 which is pilot-controlled by its own medium.

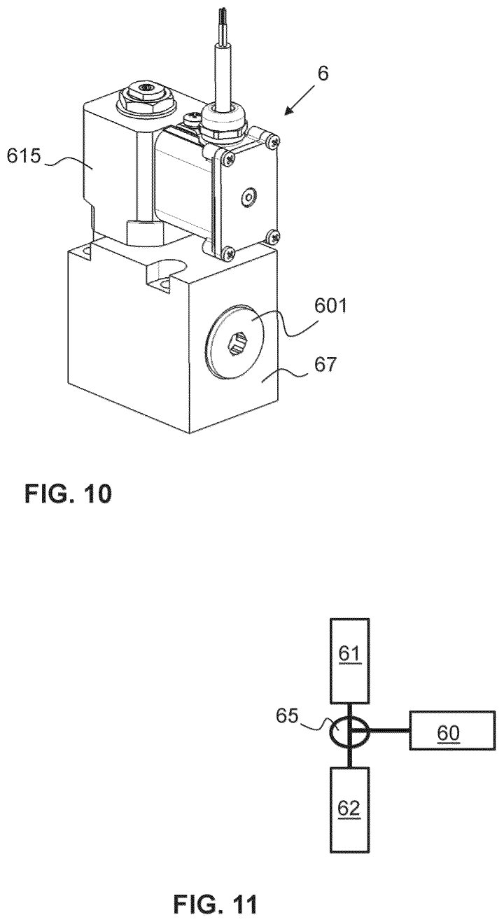

A preferred embodiment of a first valve unit 6 is illustrated in FIGS. 10 to 12. The second valve units 7 are preferably of identical design.

One feature of this valve unit 6 lies in that the main valve 60, the pilot valve 61 and the check valve 62 fluidically communicate by way of a common valve chamber 65. This is schematically illustrated in FIG. 11. For this purpose, an output of the main valve 60, an output of the pilot valve 61, and an input of the check valve 62 open toward the common valve chamber 65.

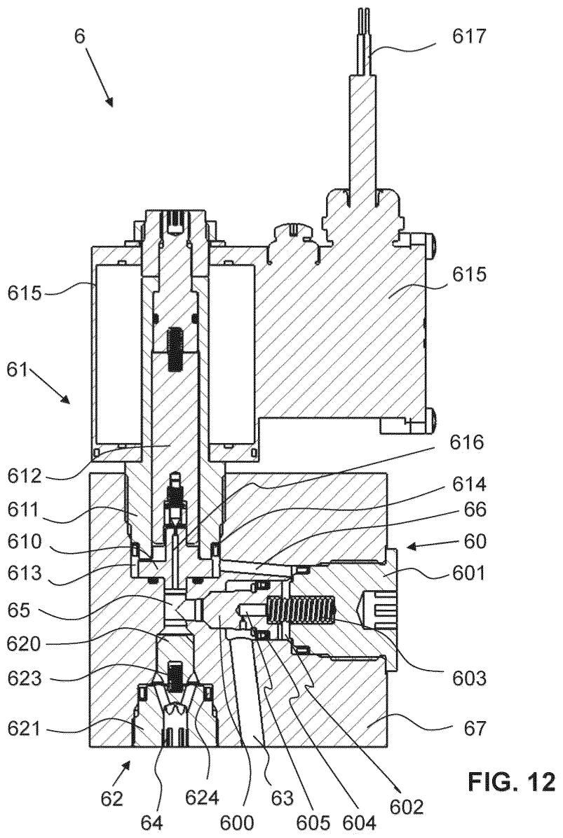

The valve unit 6 is more specifically illustrated in FIG. 12. The main valve 60, conjointly with the check valve 62, is disposed in a valve housing 67. The pilot valve 61, by way of its armature guide 611, its armature 612 and its stationary nozzle 610, protrudes into the valve housing 67. A static seal of the nozzle 610 in relation to the valve housing 67 is provided with the reference sign 614. A solenoid housing 615, which protrudes beyond the valve housing 67, has a solenoid for activating the armature 612. An electrical connector 617 establishes the connection to a controller.

An annular pressure chamber 613 surrounds the nozzle 610 of the pilot valve 61. A control line 66 leads from the pressure chamber 613 to the control chamber 602 of the main valve 60.

The main valve 60 has a movable piston 600 which by way of a spring 603 is connected to a cover 601. A bore 605 connects a tapered appendage of the inlet 63 to the control chamber 602. The cover 601 is fixedly held on the valve housing 67. The movable piston 600 is provided with a dynamic seal 604.

The inlet 63 leads from one side of the cuboid valve housing 67 to the movable piston 600 of the main valve 60, and in the case of an open position of the piston 600, to the valve chamber 65. The piston 600 in this example is surrounded by a flow. For this purpose, the piston 600 has on its circumference corresponding clearances or ribs which cannot be seen in FIG. 12. For this purpose, the piston 600 in alternative embodiments has feedthrough openings.

The check valve 62 is disposed on the same side of the valve body 67 as the inlet 63. Said check valve is located on the outlet 64. The movable piston 620 of the check valve 62 is directed toward the valve chamber 65. A valve body 621 is disposed toward the outside. The latter has a static seal 624. A spring 623 is present between the piston 620 and the valve body 621. A flow of returning fluid flows through or about the valve body 621 and closes the piston 620 of the check valve 62. In the current exemplary embodiment the piston 620 is surrounded by a flow. The corresponding clearances or ribs cannot be seen in FIG. 12.

A fluid flowing into the valve chamber 65 by way of the main valve 60 flows outward through the check valve 62. The fluid path from the inlet 63 to the outlet 64 is thus U-shaped.

The main valve 60 is pilot-controlled by its own medium by means of the pilot valve 61. In the case of a closed main valve 60 and a closed pilot valve 61, the connection between the inlet 63, the bore 605 and the control chamber 602 is open. When the pilot valve 61 is opened by means of the solenoid, the armature 612 is pulled upward, and the central duct 616 in the nozzle 610 establishes a connection from the valve chamber 65, the pressure chamber 613 of the pilot valve 61, and the control line 66 to the control chamber 602 of the main valve 60. Moreover, in the case of an open check valve 62, the connection from the valve chamber 65 to the outlet 64 is opened. Opening the pilot valve 61 thus results in a pressure drop in the control chamber 602 in comparison to the pressure in the bore 605, as a result of which the main valve 60 is opened.

When closing the pilot valve 61, the connection between the valve chamber 65 and the control chamber 602 is interrupted. The pressure in the bore 605 and in the control chamber 602 is identical; the pressure in the valve chamber 65 is lower due to the open check valve 62. The piston 600 closes thanks to the spring 603, meaning that the piston 600 moves toward the left in FIG. 12.

However, other main valves, pilot valves and check valves can also be used in the U-shaped arrangement according to the invention. The example illustrated here is merely a variant, the valves thereof potentially being replaced partially or entirely by known valves.

The surface of the valve housing 67 is preferably designed to be planar in the region of the inlet 63 and of the outlet 64. This facilitates assembly on the line module 1.

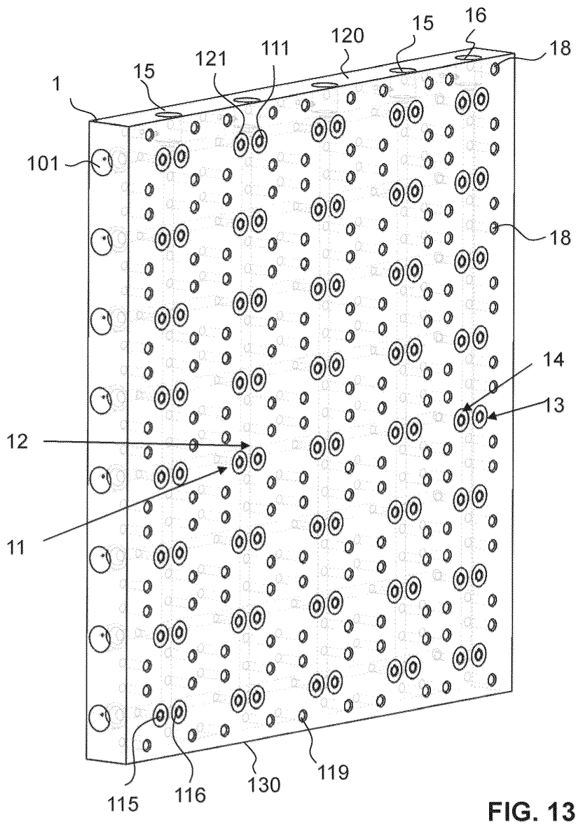

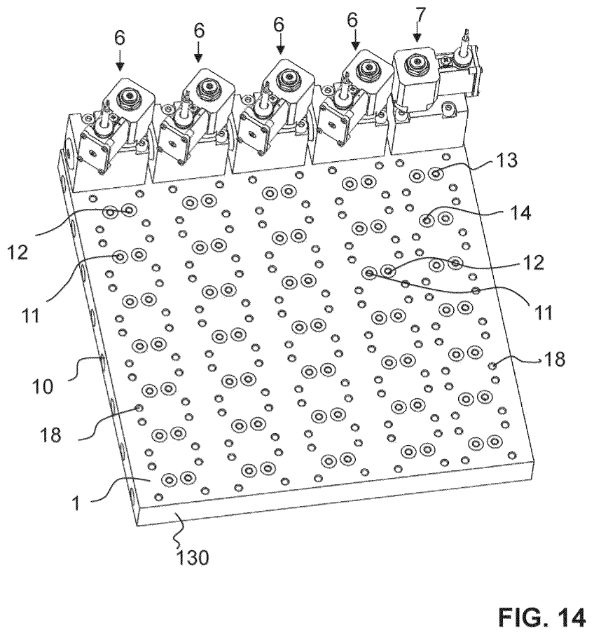

A second embodiment of the line module 1 according to the invention is illustrated in FIGS. 13 and 14. It can be used together with the same first and second valve units 6, 7 as the first exemplary embodiment. The bores and the lines are likewise the same. What has been discussed above thus applies here, too. The difference in comparison to the first exemplary embodiment lies in that the line module 1 consists of a single solid component. The latter is a thick plate, in particular of metal, for example steel, which is provided with bores in order to achieve the lines and fixing possibilities for the valve units 6, 7 described above. The two end beams 2, 3 are not required.

As can be seen in FIG. 13, the fuel dispenser lines 15 and the cryopump line 16 penetrate the upper end face 120 of the line module 1. The opposite lower end face 130 is of a closed design, as can be seen in FIG. 14. This is to be understood in a purely exemplary manner. This line module 1 can be used in any spatial position, as can also the line module according to the first embodiment.

Some valve units 6, 7 are illustrated in the assembled position in FIG. 14. The line module 1 in this embodiment can also be completely populated, as is shown for the first exemplary embodiment in FIG. 2.

The manifold according to the invention enables a compact in space-saving arrangement of valve units which can moreover be easily replaced. Each valve unit preferably comprises a main valve, a pilot valve and a check valve.

LIST OF REFERENCE SIGNS

| | | | |
|---|---|---|---|
| 1 | Line module | 602 | Control chamber |
| 10 | Storage container line | 603 | Spring |
| 101 | Expansion | 604 | Dynamic seal |
| 11 | First valve line | 605 | Bore |
| 12 | Second valve line | 61 | Pilot valve |
| 13 | Third valve line | 610 | Armature |
| 14 | Fourth valve line | 611 | Armature guide |
| 15 | Fuel dispenser line | 612 | Armature |
| 16 | Cryopump line | 613 | Pressure chamber |
| 17 | Through-bore | 614 | Static seal |
| 18 | Threaded bores | 615 | Solenoid housing |
| 100 | Line module element | 616 | Central duct |
| 120 | First end face | 617 | Electrical connector |
| 130 | Second end face | 62 | Check valve |
| | | 620 | Piston |
| 2 | First end beam | 621 | Valve body |
| 20 | Fastening bores | 623 | Spring |
| 21 | Threaded opening | 624 | Static seal |
| 201 | Expansion | 63 | Inlet |
| | | 64 | Outlet |
| 3 | Second end beam | 65 | Valve chamber |
| 30 | Fastening bores | 68 | Control line |
| 31 | Through-bores | 67 | Valve housing |
| | | 68 | Screw |
| 4 | Connecting screws | | |
| 40 | Nut | 7 | Valve unit of the cryopump |
| | | | station |
| 5 | Eye | B1 | First storage container |
| 6 | Valve unit of the consumer | B2 | Second storage container |
| | station | B3 | Third storage container |
| 60 | Main valve | B4 | Fourth storage container |
| 600 | Piston | B5 | Fifth storage container |
| 601 | Cover | B6 | Sixth storage container |
| B7 | Seventh storage container | | consumer station |
| B8 | Eighth storage container | Z2 | Second fuel dispenser |
| BL | First line | | second consumer station |
| CP | Cryopump station | Z3 | Third fuel dispenser/third |
| CL | Second line | | consumer station |
| T | Tanker | Z4 | Fourth fuel dispenser/fourth |
| V | Manifold | | consumer station |
| Z1 | First fuel dispenser/first | ZL | Third line |

1. A manifold of a fluid supply system,
having lines for connecting storage containers to stations,
having valve units for selectively opening and closing the connection between the storage containers and the stations,
characterized wherein
the lines are disposed in the form of a matrix in a line module, and
the valve units in the form of a matrix are releasably fastened on the line module.

2. The manifold as claimed in claim 1, wherein the line module consists of at least one solid component, and wherein the lines are bores in the at least one solid component.

3. The manifold as claimed in claim 2, wherein the line module consists of a single solid component.

4. The manifold as claimed in claim 2, wherein the line module has a plurality of cuboid elongate components, wherein each component establishes the connection to one storage container or to one station, and wherein a plurality of components of this type are able to be joined to one another so as to form common lines.

5. The manifold as claimed in claim 1, wherein each valve unit has a main valve, a pilot valve for controlling the main valve, and a check valve, which form a common module which is able to be fastened to the line module and released from the line module as a unit.

6. The manifold as claimed in claim 5, wherein a flow path of the fluid through the valve unit from an inlet to an outlet of the valve unit is U-shaped.

7. The manifold as claimed in claim 5, wherein at least the main valve and the check valve are disposed in a common valve housing.

8. The manifold as claimed in claim 5, wherein the valve unit has a valve chamber toward which the output of the main valve, the output of the pilot valve, and the input of the check valve open.

9. The manifold as claimed in claim 1, wherein one part of the lines of the line module are storage container lines, wherein each storage container line connects in each case one storage container to a first sub-quantity of the valve units, and wherein another part of the lines of the line module are station lines, wherein each station line connects a second sub-quantity of the valve units to in each case one station.

10. The manifold as claimed in claim 9, wherein the first sub-quantity and the second sub-quantity are not identical, and wherein exactly one valve unit of the manifold is present in the first and the second sub-quantity.

11. The manifold as claimed in claim 9, wherein the storage container lines extend in a first direction of a matrix, and the station lines extend in a second direction of the matrix that extends perpendicularly to the first direction, wherein the storage container lines extend so as to be spaced apart from the station lines.

12. The manifold as claimed in claim 2, wherein first valve lines are present, which extend from the storage container lines to the valve units at an angle to the storage container lines, and wherein second valve lines are present, which extend from the station lines to the valve units at an angle to the station lines.

13. The manifold as claimed in claim 9, wherein exactly one storage container line is present per storage container, and exactly one station line is present per station, wherein the storage container line and the station line extend without any interruption and rectilinearly in the line module.

14. The manifold as claimed in claim 1, wherein at least one station is a consumer station, and wherein at least one additional station is a cryopump station for filling the storage containers, wherein the valve units assigned to the at least one consumer station differ at least in terms of their arrangement from the valve units assigned to the cryopump station.

15. A valve unit, in particular for use in a manifold as claimed in claim 1, wherein said valve unit has a main valve, a pilot valve for controlling the main valve, and a check valve, wherein those form a common module which is able to be assembled and removed as a unit, wherein the main valve, the pilot valve and the check valve are mutually disposed in such a manner that a U-shaped or a V-shaped flow path for a flow of a fluid from an inlet into the valve unit to an outlet from the valve unit is formed.

16. A valve unit, for use in a manifold as claimed in claim 1, wherein said valve unit has a main valve, a pilot valve for controlling the main valve, and a check valve, wherein those form a common module which is able to be assembled and removed as a unit, wherein the main valve, the pilot valve and the check valve are mutually disposed in such a manner that a flow path for a flow of a fluid from an inlet into the valve unit to an outlet from the valve unit is formed, wherein the inlet and the outlet are disposed on the same side of the module.

17. The manifold as claimed in claim 1 wherein the manifold is a manifold of a hydrogen filling station.

18. The manifold as claimed in claim 14 wherein the consumer station is a fuel dispenser.
